(19) United States
(12) Patent Application Publication
(10) Pub. No.: US 2011/0111189 A1
(43) Pub. Date: May 12, 2011

(54) POLYMERIC SHEET MATERIAL AND METHOD OF MANUFACTURING SAME

(76) Inventor: Rodd S. Gilbert, Solon, OH (US)

(21) Appl. No.: 13/001,481

(22) PCT Filed: Jun. 26, 2009
(86) PCT No.: PCT/US09/48900

§ 371 Date: Dec. 27, 2010

Related U.S. Application Data
(60) Provisional application No. 61/076,287, filed on Jun. 27, 2008.

(51) Int. Cl. B32B 3/10; C08L 27/06; C08L 23/06; C08L 23/12; C08L 33/20

(52) U.S. Cl. 428/206; 525/186; 525/189; 525/190; 525/239; 525/240; 525/238; 525/222

(57) ABSTRACT

A section of polymeric sheet material includes a quantity of primary polymer and a plurality of particles of at least one non-primary polymer. A plastic card formed from the section of polymeric sheet material and a method of manufacturing polymeric sheet material are also included.

### BACKGROUND

The present application broadly relates to plastic card stock and plastic cards formed therefrom that are manufactured, at least in part, from material comprising recycled plastic scrap and to processes for manufacturing plastic card stock and plastic cards from such recycled plastic scrap material.

Plastic cards have become ubiquitous in day-to-day life and are employed for a wide variety of purposes. For example, plastic card stock is used to manufacture transaction cards (e.g., credit cards, gift cards and debit cards), identification cards (e.g., driver licenses, membership cards and security badges), information cards (e.g., promotional and marketing cards), and other plastic cards, including those having information stored thereon, such as on a magnetic strip, for example.

Conventional or standard plastic card manufacturing processes typically involve the production of relatively large, unfinished stock sheets of polymeric material. This unfinished sheet stock is normally sized to allow a plurality of plastic cards to be cut therefrom. The unfinished sheet stock is produced using any one of a variety of known manufacturing processes, such as calendaring or extruding, for example. The unfinished sheet stock is typically then cut and/or trimmed into finished sheets of stock material that are sized to customer specifications or are of appropriate dimensions for further processing.

While other virgin homopolymeric and/or co-polymeric materials may alternately be used in some card applications, virgin PVC is presently the material of choice for use in the manufacture of plastic card stock and plastic cards. The use of virgin PVC is due at least in part to the durability and price of virgin PVC, as compared with other virgin plastic materials. However, the use of virgin material exclusively or even in a substantial or large quantity may be considered problematic for a variety reasons. One example of such a reason is that the use of virgin PVC can still significantly contribute to the cost of an associated product, though it may be more economical than other virgin materials.

Recently, processes have been developed to manufacture polymeric sheet material (e.g., plastic card stock) from recycled plastic scrap material rather than virgin resin. Such processes for manufacturing polymeric sheet material (and cards formed therefrom) from recycled plastic scrap material are discussed in detail in one or more pending patent applications filed in the name of the present inventor. One application, which has been assigned Ser. No. 11/405,300, was filed on Apr. 17, 2006 and is entitled SHEET STOCK AND CARDS MADE FROM RECYCLED PLASTIC SCRAP MATERIAL AND METHODS. Another application, which has been assigned U.S. Ser. No. 11/541,823, was filed on Sep. 29, 2006 and is entitled METHODS OF PRODUCING AND RECYCLING PLASTIC CARDS. The entire contents of each of these applications is hereby incorporated herein by reference.

While plastic card stock manufactured by the foregoing processes utilizing recycled plastic scrap material have met with great success, it has been generally believed that other, non-primary polymeric materials should be substantially, if not entirely, absent from the quantity of primary polymeric material that is to be reused in these processes. That is, plastic scrap material suitable for use in such known processes is often collected from single-material sources, such as manufacturers that produce products from only a single polymeric material. In other cases, scrap material can be recovered and reused from internal processes, such as scrap or waste material from set-up sheets, edge trim, skeletons from punching and/or die cutting, hole slugs, discarded product due to quality or overruns, waste from high dies, round corner waste, sheets rejected from lamination, waste sheets from printing and/or butt roles of overlay, for example. In still other cases, arrangements can be made with scrap-generating entities to maintain separate storage areas for different types of scrap material. The plastic scrap materials generated thereby are then sorted and/or otherwise classified as the same are generated such that single-material quantities of plastic scrap are maintained and available.

As mentioned above, known processes of utilizing recycled PVC material have successfully reused materials that may have otherwise reached a landfill. It has been recognized, however, that tremendous quantities of plastic scrap material exists in which a reusable primary material is intermixed with quantities of other, non-primary polymeric materials. It will be appreciated that the inclusion of even a substantially small amount of non-primary polymeric materials (e.g., less than one-half of one percent) within a quantity of primary polymeric material will normally be enough to render the intermixed quantity of polymeric materials unusable in such known processes. For such material to be useable in the aforementioned known manufacturing processes, this mixed polymeric scrap material would need to be sorted or otherwise separated such that the reusable primary material can be separated therefrom. Commercially viable techniques for sorting or otherwise separating quantities of mixed polymeric materials into individual or families of materials are not believed to be available at the present time. So, it seems that these quantities of intermixed scrap materials are not normally used in the manufacture of plastic card stock and/or plastic cards, and are, more commonly, directed to a landfill.

Accordingly, it is believed desirable to develop polymeric sheet material, plastic card stock and plastic cards formed therefrom, and methods of manufacturing the same that utilize quantities of polymeric scrap material in which different types of plastics (i.e., a primary polymer and one or more non-primary polymers) are intermixed with one another.

### BRIEF DESCRIPTION

A section of polymeric sheet material in accordance with the subject disclosure is provided that has opposing sheet sides and an outer peripheral edge. The section of polymeric sheet material includes a quantity of primary polymer having a processing temperature. The quantity of primary polymer comprises at least 50 percent of the section of polymeric sheet material. The section of polymeric sheet material also includes a plurality of particles of at least one non-primary polymer that has a processing temperature greater than the processing temperature of the primary polymer. Due to this difference in processing temperatures, the plurality of particles of the at least one non-primary polymer remain unmelted during manufacture of the section of polymeric sheet material and become at least partially embedded within the quantity of primary polymer.

A method of manufacturing polymeric sheet material in accordance with the subject disclosure is provided that includes providing a first quantity of polymeric material that comprises a primary polymer having a first processing temperature and at least one non-primary polymer intermixed therewith. The at least one non-primary polymer has a second processing temperature that is greater than the first processing temperature of the primary material. The method also includes reducing at least the first quantity of polymeric material to polymeric particles of a predetermined and approximately-uniform size. And, the method includes processing the first quantity of polymeric material at approximately the first processing temperature to form a section of polymeric sheet material that comprises the primary polymer and a plurality of unmelted particles of the at least one non-primary polymer, which are at least partially embedded within the primary polymer.

A method of manufacturing polymeric sheet material in accordance with the subject disclosure is provided that includes providing a first quantity of polymeric material that comprises a primary polymer having a first processing temperature. The method also includes providing a second quantity of polymeric material comprising a combination of the primary polymer and at least one non-primary polymer intermixed therewith. The at least one non-primary polymer has a second processing temperature that is greater than the first processing temperature of the primary material. The method also includes reducing at least the second quantity of polymeric material to polymeric particles of a predetermined and approximately-uniform size. And, the method includes processing a predetermined percentage of the first and second polymeric materials together with one another at approximately the first processing temperature to form a section of polymeric sheet material that comprises the primary polymer and a plurality of unmelted particles of the at least one non-primary polymer, which are at least partially embedded within the primary polymer.

### BRIEF DESCRIPTION OF THE DRAWINGS

FIG. 1 is a top view of a length of polymeric sheet material comprising a primary polymer and one or more non-primary polymers, and illustrating representations of a sheet of plastic card stock and a plurality of plastic cards formable therefrom.

FIG. 2 is a cross-sectional side view of one exemplary embodiment of a section of polymeric sheet material for use as a sheet of card stock or a plastic card as shown in FIG. 1 and comprising a primary polymer and one or more non-primary polymers.

FIG. 3 is a cross-sectional side view of an alternate embodiment of the section of polymeric sheet material in FIG. 2 comprising a primary polymer and one or more non-primary polymers and including an overlay on at least one side thereof.

FIG. 4 is a cross-sectional side view of another alternate embodiment of the section of polymeric sheet material in FIG. 2 comprising a primary polymer and one or more non-primary polymers and including a veneer on at least one side thereof.

FIG. 5 is a cross-sectional side view of still another alternate embodiment of the section of polymeric sheet material in FIG. 2 comprising a primary polymer and one or more non-primary polymers and including a veneer and an overlay on at least one side thereof.

FIG. 6 is a graphical representation of particle size versus edge quality for a section of polymeric sheet material comprising a primary polymer and particles of non-primary polymers which are embedded therein.

FIG. 7 is a graphical representation of processing temperatures for one exemplary group of primary and non-primary polymers, such as may comprise a section of polymeric sheet material.

FIG. 8 is a flowchart illustrating one exemplary method of manufacturing polymeric sheet material from a primary polymer and particles of one or more non-primary polymers.

It should be recognized and appreciated that the drawings are not to scale and that the proportion of certain elements may be exaggerated for the purposes of clarity and ease of illustration.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Primary polymer,” as used herein, broadly refers to a polymeric material of a single type, kind and/or family that comprises at least 50 percent by volume of a section of polymeric sheet material, such as may be used as an inner layer or core of a sheet of plastic card stock and/or a plastic card, for example. “Primary polymer” can also include different grades of polymeric material from a common family of materials, such as grades of polyvinyl chloride having different durometers or filled and unfilled grades of polypropylene, for example. Examples of materials suitable for use as a primary polymer for forming plastic card stock and/or plastic cards include, without limitation, one or more grades of polyvinyl chloride, one or more grades of polyethylene and one or more grades of polypropylene.

“Non-primary polymer,” as used herein, broadly refers to a polymeric material of a type and/or kind that is different from that of the primary polymer. Such a non-primary polymer will typically have material properties and processing characteristics that differ from those of the primary polymeric material. Examples of materials that may be identified as and/or otherwise result in being non-primary polymers can include, without limitation, polyamides, polystyrenes, nylon, polyesters, polyester copolymers, polyacrylates, polysulfones, styrene-maleic anhydride copolymers, styrene-acrylonitrile copolymers, polymethyl methacrylates, fluoroplastics, polycarbonates, polyacrylonitriles and polycyanurates.

“Scrap polymeric material” as used herein, broadly refers to any previously processed, used, spent and/or otherwise discarded polymeric material including, but not limited to, scrap resulting from processing virgin polymeric material and/or recycled scrap material, scrap resulting from the manufacture of a sheet of plastic card stock or from the manufacture of plastic cards, and/or post-consumer scrap recovered from third parties, such as in the form of spent or discarded plastic cards, for example. Scrap polymeric material can be of either one of two types of material. One type of scrap polymeric material is referred to herein as single-polymer or classified scrap polymeric material and will generally include materials of a single type, kind and/or family of polymers (including different grades of a common family of polymers). Such single-polymer scrap material can be well suited for use as primary polymer material in connection with the subject concept. The other type of scrap polymeric material is referred to herein as multi-polymer or mixed scrap polymeric material and will generally include two or more types, kinds and/or families of polymers. Such mixed scrap polymeric material can include two or more non-primary polymeric materials without including any substantial volume or amount of primary polymer. In one preferred arrangement, however, a portion or percentage of primary polymer will be intermixed with one or more other, non-primary polymers. Additionally, scrap polymeric material may also include a relatively minor amount of additives, metallic substances, inks and other non-polymeric substances.

Terms such as “regrinding” and “reducing in size,” as used herein, broadly refer to any process that may be employed to act upon scrap polymeric material, of either a single-polymer or mixed type, to produce a sufficiently fine particle size to render the scrap polymeric material fit for use in subsequent polymeric processing methods and/or operations. Examples include, but are not limited to, grinding, shredding, pulverizing, and the like. It will be recognized, however, that different particles sizes may yield different results when used in connection with the subject processes. As such, the particle size produced from regrinding should not be considered to be limited except to the extent that the particles should be of a size sufficient or suitable to achieve the desired output, results and/or characteristics (e.g., surface finish and/or edge finish) for the section of polymeric sheet material and plastic card stock and/or plastic cards formed therefrom and be suitable for use in any corresponding polymeric processing operations such as, for example, extrusion or calendaring processes, for manufacturing the same.

Terms such as “plastic card” and “plastic card stock,” as used herein, broadly refer to any approximately flat section of polymeric material of any suitable size, shape and/or thickness. A plastic card will normally have a smaller relative size than a sheet of plastic card stock. Plastic cards can be used for any suitable purpose and can include any suitable features or elements. For example and without limitation, plastic cards can be used as transaction cards (e.g., credit cards, gift cards, debit cards), identification cards (e.g., driver licenses, membership cards, security badges, key tags, luggage tags) and/or information cards (e.g., business cards, marketing or promotional cards). A sheet of plastic card stock is generally of a larger relative size than that of plastic cards and, for example, may be dimensioned such that one or more plastic cards could be formed from the plastic material within the boundaries thereof. Additionally, a sheet of plastic card stock and/or a plastic card can include a single polymeric layer or multiple polymeric layers. Preferably, the one or more layers that comprise a sheet of plastic card stock or a plastic card will include a core or inner layer of polymeric sheet material comprising a primary polymeric material and a plurality of unmelted particles of one or more non-primary polymeric materials.

“Overlay,” as used herein, broadly refers to a substantially transparent, relatively thin layer of polymeric material suitable for use in the manufacture of a plastic card. Such substantially transparent polymeric material is often, but not necessarily, formed from virgin resin. The overlay can be adhered by heat, pressure and/or adhesive to a core or inner layer of polymeric sheet material comprising a primary polymeric material and a plurality of unmelted particles of one or more non-primary polymeric materials. Alternately, the overlay can be adhered to a veneer as described herein. The overlay can optionally contain a pre-applied magnetic strip and/or a pre-applied adhesive as may be desired for a particular application.

Terms such as “cap,” “cover layer” and “veneer,” as used herein, broadly refer to a relatively thin layer of polymeric material, such as, for example, virgin polymeric material, suitable for use in the manufacture of a plastic card, such as to cover or otherwise extend over at least a portion of the core or inner layer. A cap or veneer can be used to visually obscure the core layer and thereby aesthetically improve the appearance thereof and/or provide information and/or images thereon. The veneer can be adhered by heat, pressure and/or adhesive to the core or inner layer of polymeric sheet material comprising a primary polymeric material and a plurality of unmelted particles of one or more non-primary polymeric materials.

This application describes numerous embodiments of a section of polymeric material that is suitable for use as or for use in forming a sheet of plastic card stock or a plastic card that is constructed, at least in part, from a primary polymer and a plurality of unmelted particles of one or more non-primary polymers. For example, in one—material.

As mentioned above, a plastic card and/or a sheet of plastic card stock can include a single layer or multiple layers, which include one or more core layers and can optionally include one or more veneer layers and/or one or more overlay layers. In an exemplary embodiment, at least one or more of the core or inner layers is at formed from a plurality of particles the primary polymer, such as from at least one of virgin resin and single-polymer scrap polymeric material, and from a plurality of particles of one or more non-primary polymers, such as from mixed scrap polymeric material. Among other benefits, such a construction can reduce the cost of manufacturing plastic cards and/or plastic card stock and can reduce the overall environmental impact of the production of the same.

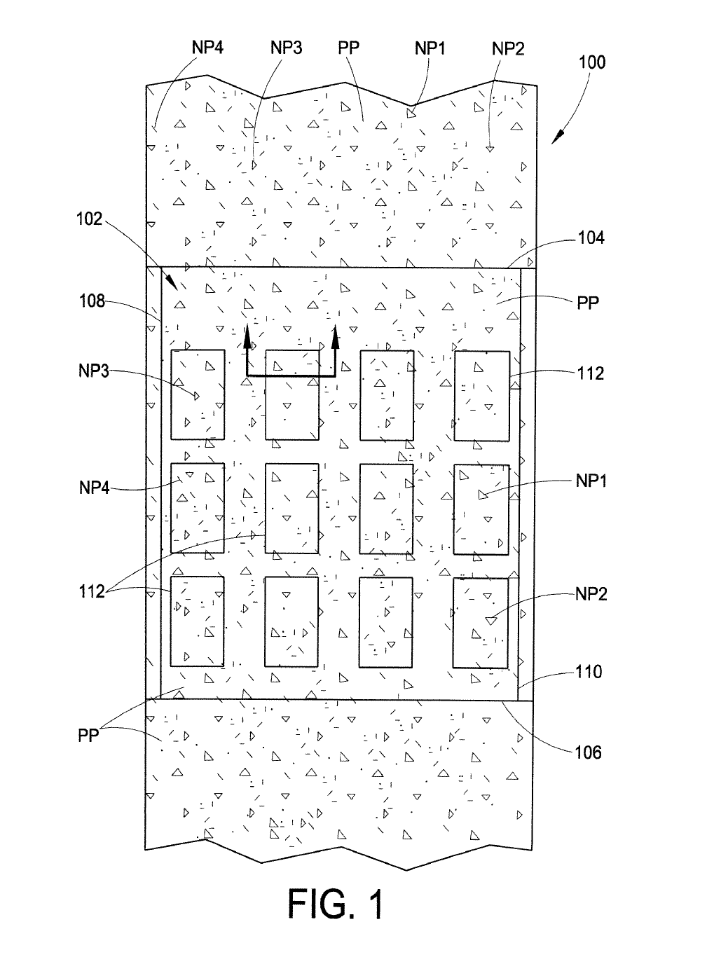

FIG. 1 is a top plan view of one exemplary embodiment of a length of unfinished sheet stock 100 formed from material comprising a unified mass of primary polymer PP and a plurality of particles of one or more non-primary polymers NP1-NP4 at least partially embedded within the unified mass of primary polymer. The unfinished sheet stock is suitable for use in forming a sheet of plastic card stock 102 from a section of polymeric material disposed between first and second trim lines 104 and 106. Optionally, sheet 102 can be further sized and/or shaped by cutting or trimming additional portions of the section of polymeric material, such as along additional third and fourth trim lines 108 and 110. The unfinished sheet stock is also suitable for use in forming one or more plastic cards, such as are represented by trim lines 112, for example. Such plastic cards could be cut to an approximate size or shape directly from a section of polymeric material from unfinished sheet stock 100 or alternately from sheet 102, such as after further processing operations thereof, for example.

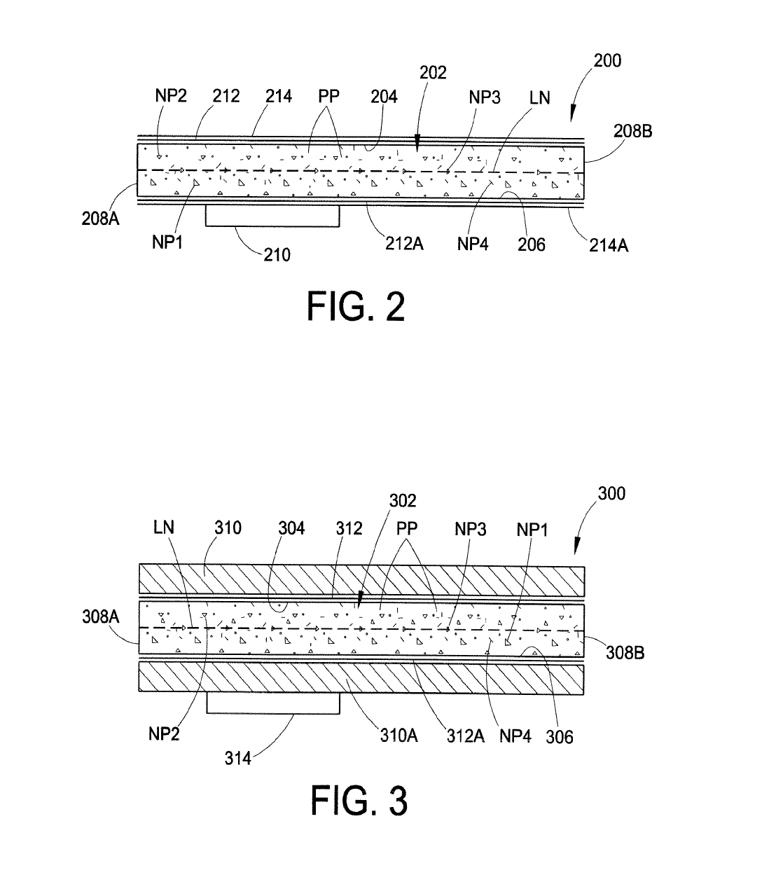

FIG. 2 is a cross-sectional side view of one embodiment of a section of polymeric material 200 that is suitable for use as a sheet of plastic card stock or a plastic card. Section of polymeric material 200 includes a core layer 202 having a first or top surface 204, an opposing second or bottom surface 206, and an outer peripheral edge, which is partially represented in FIG. 2 by opposing edges 208A and 208B. In one exemplary embodiment, core layer 202 can be comprised of a unified mass of a primary polymer PP and a plurality of particles of one or more non-primary polymers (e.g., non-primary polymers NP1-NP4) that are at least partially embedded within the primary polymer.

Optionally, an information storage device can be provided on or along either one or both surfaces of the core layer. In the exemplary embodiment shown, a magnetic strip 210 is shown disposed along bottom surface 206. It will be appreciated, however, that any other suitable construction can alternately be used. Additionally, printing or markings can be provided on or along one or both of surfaces 204 and 206 of core layer 202. In the exemplary embodiment shown, printing 212 is disposed along first surface 204. An optional clear coating 214, such as ink, lacquer or another suitable substance, for example, can be applied along one or both of surfaces 204 and 206. In one exemplary embodiment, such an optional clear coating 214 extends over any printing or marking that may be included, such as printing 212, for example. Additionally, printing 212A can optionally be provided along second surface 206 and a second clear coating 214A can optionally be provided along at least a portion of printing 212A.

Core layer 202 of section of polymeric material 200 can comprise a single layer or ply. Alternately, two or more plies of core material could be secured to one another, such as is represented by dashed line LN in FIG. 2, for example, to form core layer 202.

FIG. 3 is a cross-sectional side view of another embodiment of a section of polymeric material 300 that is suitable for use as a sheet of plastic card stock or a plastic card. Section of polymeric material 300 includes a core layer 302 having a first or top surface 304, an opposing second or bottom surface 306, and an outer peripheral edge, which is partially represented in FIG. 3 by opposing edges 308A and 308B. In one exemplary embodiment, core layer 302 can be comprised of a unified mass of a primary polymer PP and a plurality of particles of one or more non-primary polymers (e.g., non-primary polymers NP1-NP4) that are at least partially embedded within the primary polymer.

In the exemplary embodiment shown in FIG. 3, section 300 includes a first overlay 310 disposed along first surface 304. Additionally, printing or marking can be provided on or along one or both of surfaces 304 and 306 of core layer 302. In the exemplary embodiment shown, printing 312 is disposed along first surface 304 and first overlay 310 extends across printing 312 substantially covering the same. As discussed above, such overlays are preferably formed from an approximately transparent material and are operative to protect the core layer as well as any printing thereon. Furthermore, printing 312A can optionally be provided on or along second surface 306.

Optionally, an information storage device can be provided on or along either one or both surfaces of the core layer. In the exemplary embodiment shown, a magnetic strip 314 is shown disposed along bottom surface 306. It will be appreciated, however, that any other suitable construction can alternately be used. Additionally, second overlay 310A could optionally be provided and secured along second surface 306 of core layer 302. Such a second overlay would be operative to protect the second surface of the core layer, as well as protect any printing or markings (e.g., printing 312A) that may be included along the second surface.

Core layer 302 of section of polymeric material 300 can comprise a single layer or ply. Alternately, two or more plies of core material could be secured to one another, such as is represented by dashed line LN in FIG. 3, for example, to form core layer 302.

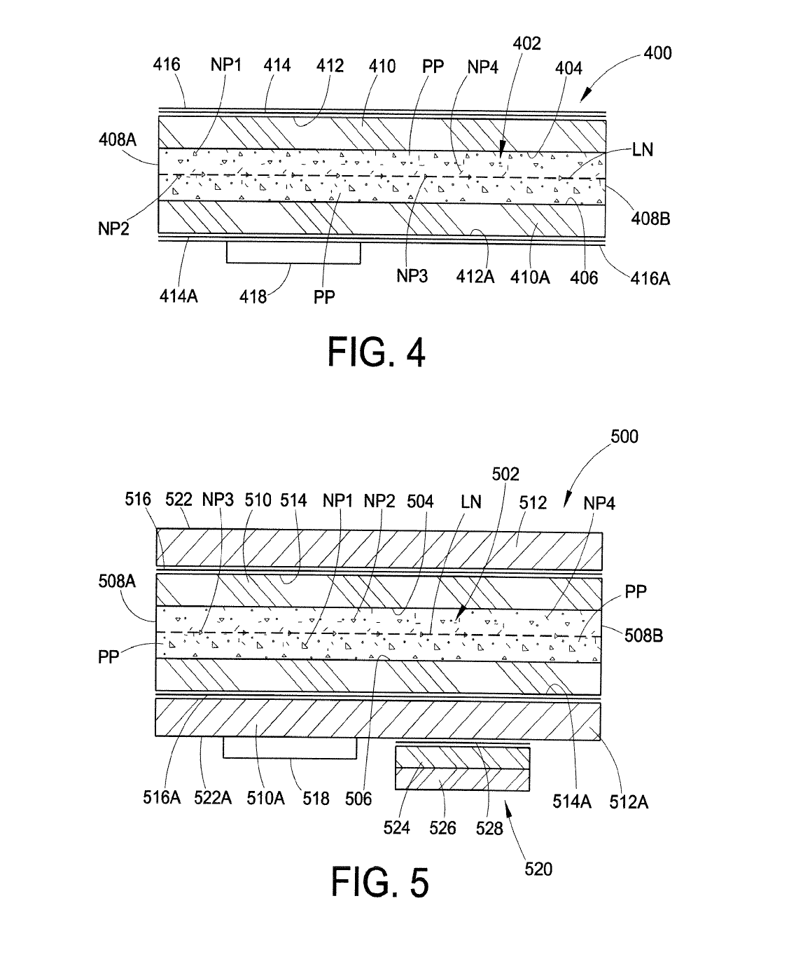

FIG. 4 is a cross-sectional side view of still another embodiment of a section of polymeric material 400 that is suitable for use as a sheet of plastic card stock or a plastic card. Section of polymeric material 400 includes a core layer 402 having a first or top surface 404, an opposing second or bottom surface 406, and an outer peripheral edge, which is partially represented in FIG. 4 by opposing edges 408A and 408B. In one exemplary embodiment, core layer 402 can be comprised of a unified mass of a primary polymer PP and a plurality of particles of one or more non-primary polymers (e.g., non-primary polymers NP1-NP4) that are at least partially embedded within the primary polymer.

In the exemplary embodiment shown in FIG. 4, section 400 includes a first and second cap layers or veneers 410 and 410A, respectively disposed along first and second surfaces 404 and 406 of core layer 402. The first and second veneers have an outer surface 412 and 412A, respectively. Typically, a veneer is included for informational or aesthetic purposes and, thus, can provide an aesthetically appealing outward appearance and/or can, optionally, also include printing or marking provided thereon. As shown in FIG. 4, printing or other markings 414 and 414A can optionally be provided on or along outer surfaces 412 and 412A of the first and second veneers. As another alternative, one or both of the first and second veneers can optionally include an approximately transparent portion (not shown), and printing or other markings can be provided on or along one or both of surfaces 404 and 406 of core layer 402.

An optional clear coating 416 and/or 416A, such as ink, lacquer or another suitable substance, for example, can be applied along either or both of surfaces 412 and 412A of the respective veneers. In one exemplary embodiment, such an optional clear coating extends over any printing or markings, such as markings 414 and/or 414A, for example, that may be included.

Optionally, an information storage device can be provided on or along either one or both surfaces of the core layer. In the exemplary embodiment shown, a magnetic strip 418 is shown disposed along outer surface 412A of second veneer 410A. It will be appreciated, however, that any other suitable construction can alternately be used.

Core layer 402 of section of polymeric material 400 can comprise a single layer or ply. Alternately, two or more plies of core material could be secured to one another, such as is represented by dashed line LN in FIG. 4, for example, to form core layer 402.

FIG. 5 is a cross-sectional side view of yet another embodiment of a section of polymeric material 500 that is suitable for use as a sheet of plastic card stock or a plastic card. Section of polymeric material 500 includes a core layer 502 having a first or top surface 504, an opposing second or bottom surface 506, and an outer peripheral edge, which is partially represented in FIG. 5 by opposing edges 508A and 508B. In one exemplary embodiment, first layer 502 can be comprised of a unified mass of a primary polymer PP and a plurality of particles of one or more non-primary polymers (e.g., non-primary polymers NP1-NP4) that are at least partially embedded within the primary polymer.

In the exemplary embodiment shown in FIG. 5, section 500 includes a first cap layer or veneer 510 disposed along first surface 504 and a first overlay 512 disposed along an outer surface 514 of first veneer 510. Typically, a veneer is included for informational or aesthetic purposes and, thus, can provide an aesthetically appealing outward appearance and/or can, optionally, also include printing or marking provided thereon. As shown in FIG. 5, printing or other markings 516 can be provided on or along outer surface 514 of first veneer 510 and can be at least partially covered by first overlay 512. Alternately, first veneer 510 can optionally include an approximately transparent portion (not shown) and printing or other markings can be provided on or along one or both of surfaces 504 and 506 of core layer 502. A second cap layer or veneer 510A can optionally be disposed along second surface 506 and a second overlay 512A can optionally be disposed along an outer surface 514A of the second veneer. Additionally, printing or other markings 516A can optionally be provided on or along outer surface 514A and can be at least partially covered by the second overlay.

Optionally, an information storage device can be provided on or along either one or both surfaces of the first layer. In the exemplary embodiment shown, a magnetic strip 518 is shown disposed along second overlay 512A. It will be appreciated, however, that any other suitable construction and/or arrangement can alternately be used.

An optional removable layer, such as a scratch-off label 520, can be included on or along any surface of section 500, such as either one or both of surfaces 522 and 522A of overlays 512 and 512A, respectively. In the exemplary embodiment shown in FIG. 5, scratch-off label 520 includes an approximately transparent polymeric layer 524 and a removable opaque coating 526 disposed along surface 522A of overlay 510A overtop of transparent polymeric layer 524. Generally, printing or markings will be provided on a surface of the section of polymeric material, such as printing 528 disposed along surface 522A, and scratch-off label 520 will be disposed along the surface to obscure or hide the printing or markings. The printing or markings can be revealed by removing opaque coating 526 of scratch-off label 520.

Transparent polymeric layer 524 can generally be made from any polymeric material including, polyesters, polystyrenes, polypropylene, polysulfone, alamide, polycarbonate, polyvinyl alcohol, polyvinyl chloride, and the like. Additionally, removable opaque coating 526 can be formed from any suitable material that can be removed or partially removed by scraping, scratching or another similar action. Materials suitable for use as a removable opaque coating are known in the art. Additionally, the removable opaque coating may be applied by any suitable method including, but not limited to, heat, pressure, adhesive, and the like.

It will be appreciated that any of the above-described exemplary sections of polymeric material shown in FIGS. 2-5 are merely exemplary and that any combination of the foregoing features, elements, arrangements and/or constructions can be used. However, it will also be appreciated that any of the foregoing exemplary sections of polymeric material or others suitable for use in forming a sheet of plastic card stock or for use as plastic cards, including, without limitation, those described above with regard to FIGS. 2-5, will preferably be at least partially constructed from a unified mass of a primary polymer PP and a plurality of particles of one or more non-primary polymers (e.g., non-primary polymers NP1-NP4) that are at least partially embedded within the primary polymer. Additionally, it will be appreciated that the various constructions described herein can include one or more other devices or components of any suitable type or kind applied on or embedded therein, such as IC chips, for example.

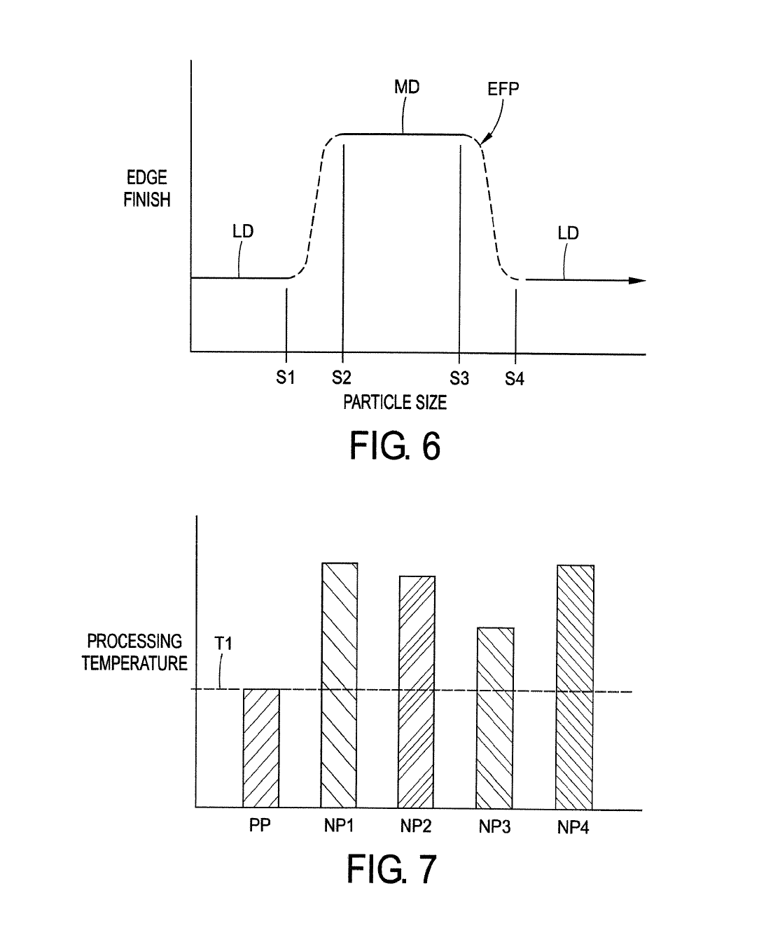

FIG. 6 is a graphical representation of particle size versus edge finish for a section of polymeric sheet material (e.g., sections 100, 200, 300, 400 and/or 500) comprised of a unified mass of a primary polymer PP and a plurality of particles of one or more non-primary polymers (e.g., non-primary polymers NP1-NP4) that are at least partially embedded within the primary polymer. It will be appreciated that different types of cutting operations can be used to produce or otherwise generate sheets of plastic card stock, plastic cards and other products formed from sections of polymeric sheet material. It has been recognized that the quality of edge finish obtained during the production of such sheets of plastic card stock, plastic cards and other such products will vary with respect to the size of the particles of the non-primary polymers. Thus, different edge finishes can be achieved by determining an appropriate size or size range for the particles of non-primary polymers and manufacturing sections of polymeric sheet material using the same.

FIG. 6 illustrates an edge finish curve or profile EFP having less desirable portions LD at which a lower quality edge finish is achieved and a more desirable portion MD at which a higher quality edge finish is achieved. At particle sizes up to size S1 and particle sizes above size S4, lower quality edge finishes have been achieved. In a size range between sizes S2 and S3, higher quality edge finishes have been achieved. At sizes between S1 and S2 and between S3 and S4, edge finishes of a variety of qualities may occur. While it will be appreciated that the desired quality of edge finish will vary from application-to-application, it is believe that edge finish profile EFP is representative of certain applications and/or uses in which polymeric material is of comprised of a unified mass of a primary polymer PP and a plurality of particles of one or more non-primary polymers (e.g., non-primary polymers NP1-NP4) that are at least partially embedded within the primary polymer.

As one example, such an edge finish profile may be representative of the edge finishes for plastic card stock and plastic cards that are comprised of a unified mass of a primary polymer PP and a plurality of particles of one or more non-primary polymers (e.g., non-primary polymers NP1-NP4) that are at least partially embedded within the primary polymer. In such an application, particles sizes of from about 0.01 inches to about 0.25 inches may represent size S2 and S3, respectively.

FIG. 7 is a graphical representation processing temperatures for one exemplary group of polymeric materials that include a primary polymer and one of more non-primary polymers. As shown in FIG. 7, primary polymer PP has a temperature, represented by line T1, that is suitable for processing (i.e., melting) the polymer using a suitable manufacturing operation or process to generate sections of polymeric sheet material. FIG. 7 also illustrates the processing temperatures of a plurality of non-primary polymers, such as are represented by reference numbers NP1-NP4, for example.

During manufacturing of a section of polymeric sheet material, the particles of primary and non-primary polymers will be processed at the processing temperature of the primary polymer (i.e., temperature T1). Thus, it will be recognized that the one or more non-primary polymers have processing temperatures that are greater than temperature T1 of the primary polymer will remain substantially unmelted. As such, the particles of non-primary polymers will be at least partially embedded within the primary polymer, which will flow around the unmelted particles and form a unified mass of primary polymer. It should be recognized that any given quantity of mixed scrap polymeric material may contain one or more non-primary polymers having a processing temperature greater than that of the primary polymer. However, in some cases, some other non-primary polymers may processing temperatures approximately equal to, or even less than, that of the primary polymer.

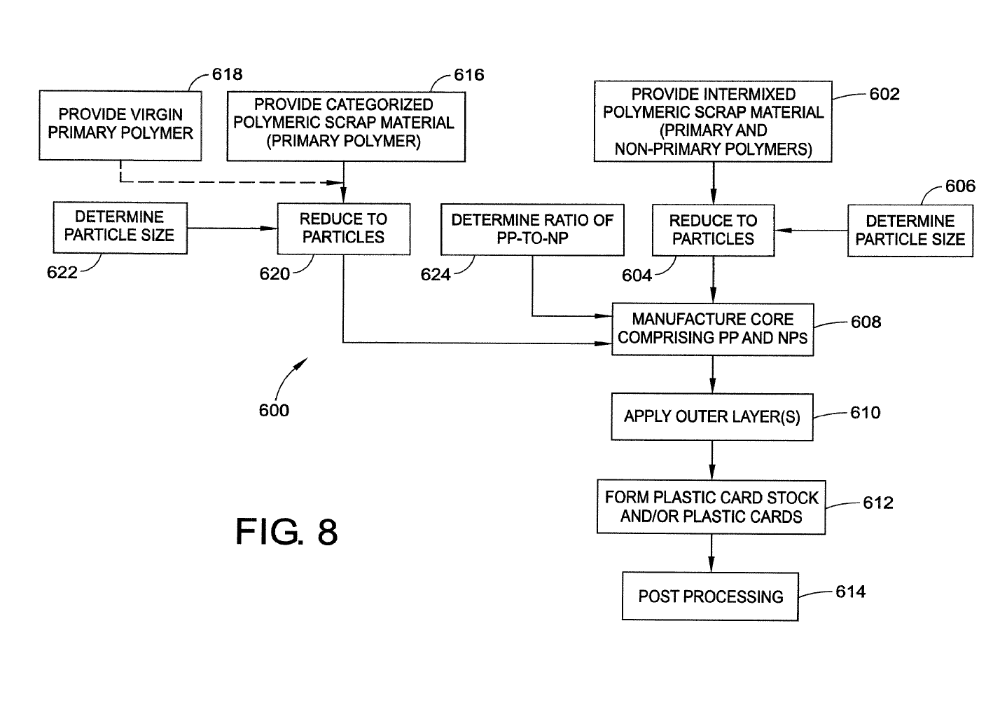

Turning now to FIG. 8, a method 600 for manufacturing a section of polymeric material comprised of a unified mass of a primary polymer PP and a plurality of particles of one or more non-primary polymers (e.g., non-primary polymers NP1-NP4) that are at least partially embedded within the primary polymer is provided that is suitable for use in forming a sheet of plastic card stock or for use as plastic cards. The method includes providing a quantity of polymeric material for use as the primary polymer in manufacturing a section of polymeric sheet material in accordance with the subject disclosure. The method also includes providing a quantity of polymeric material comprising one or more non-primary polymers for use in combination with the primary polymer in manufacturing a section of polymeric sheet material in accordance with the subject disclosure. It will be appreciated that such quantities of polymeric scrap material can be provided from any suitable source or sources, such as have been discussed above and such as are discussed in the aforementioned pending patent applications, for example. Additionally, it will be appreciated that such quantities of polymeric material can be provided in any suitable manner, form and/or condition. As one example, the primary and non-primary polymeric materials can be intermixed with one another as a quantity of polymeric scrap material, such as is indicated by box 602 in FIG. 8.

Regardless of the source of the quantity or quantities of polymeric material that comprise the primary and non-primary polymers, method 600 can also include reducing such quantities of polymeric material to particles of a predetermined and approximately uniform size, as indicated by box 604 in FIG. 8. As discussed above, the operation of reducing the quantities of materials to such particles can be accomplished in any suitable manner. Examples of suitable regrinding methods include, but are not limited to, grinding, shredding, pulverizing, and the like. Method 600 can also optionally include an action of making a determination as to an appropriate size for reducing the quantities of material, as is represented by box 606 in FIG. 8. It will be recognized that any such determination will vary from application-to-application depending upon a wide variety of factors, such as desired edge finish, as discussed above with regard to FIG. 6.

Once the primary polymer and one or more non-primary polymers have been reduced to particles of the predetermined size, as indicated by box 604, method 600 includes manufacturing a section of one or more layers of core material, as is indicated by box 608. The section can be formed using any suitable plastics processing method or operation, including continuous processes (e.g., extrusion) or non-continuous processes. Suitable plastics processing methods include, but are not limited to, calendaring, extrusion, co-extrusion, and the like.

As discussed above, a section of core material manufactured in accordance with method 600 will have a plurality of unmelted particles of non-primary polymer embedded therein. As such, method 600 can optionally include manufacturing or otherwise providing material for applying one or more outer layers to either or both sides of the section of core material and applying such one or more outer layers, as is indicated by box 610 in FIG. 8. It will be appreciated that such one or more outer layers can include any combination of printing, marking, clear coating, veneers, overlays and the like, without limitation, such as have been discussed above, for example.

Method 600 can optionally include forming a sheet of plastic card stock and/or plastic cards from a section of polymeric sheet material, as indicated by box 612. Such an action can include any suitable methods, processes and/or operations, including, without limitation, cutting, trimming, shearing, punching, stamping, forming, molding, die cutting, or the like.

Furthermore, method 600 can optionally include one or more post processing operations, as indicated by box 614. Such post processing operations can be performed approximately concurrently with or after forming a section of polymeric material. Alternatively, such post processing operations can be performed approximately concurrently with or after forming the sheet of plastic card stock or plastic cards, as is indicated by box 612. Such post processing steps can include any suitable step or series of steps, such as, without limitation, personalization, printing, encoding a magnetic strip, embossing and scoring, for example.

A method according to the subject disclosure, such as method 600, for example, includes providing a quantity of polymeric material for use as the primary polymer in manufacturing a section of polymeric sheet material in accordance with the subject disclosure and providing a quantity of polymeric material comprising one or more non-primary polymers for use in combination with the primary polymer in manufacturing a section of polymeric sheet material in accordance with the subject disclosure. Such quantities of polymeric material can be intermixed with one another, such as has been discussed with regard to box 602, for example. As another example, a quantity of primary polymeric material can be provided in addition to the quantity of primary polymeric material that is intermixed with the quantity of non-primary polymeric materials. As a further example, a quantity of primary polymer can be provided in the alternative to the quantity of primary polymeric material that is intermixed with the quantity of non-primary polymeric material.

As such, method 600 can optionally include providing one or more quantities of primary polymeric material for use in combination with, or in the alternative to, the aforementioned quantity of primary polymer that may be intermixed or otherwise provided together with a quantity of non-primary polymeric materials. Any such one or more quantities of primary polymeric material can be provided in any suitable manner, form and/or condition, and can be provided from any suitable source. For example, the method can include providing one or more quantities of single-polymer or otherwise categorized scrap polymeric material, as is indicated by box 616 in FIG. 8. Again, it will be appreciated that such one or more quantities of single-polymer or otherwise categorized scrap polymeric material can be provided from any suitable source, such as has been discussed above and such as is discussed in the aforementioned pending patent applications, the entire disclosures of which are hereby incorporated herein by reference. As another example, or in addition to the foregoing example, method 600 can also optionally include providing virgin polymeric material for use as the primary polymer, as indicated by box 618 in FIG. 8.

Regardless of the source of any such additional quantities of polymeric material for use as the primary polymer, method 600 can also optionally include reducing such quantities of polymeric material to particles of a predetermined and approximately uniform size, as indicated by box 620 in FIG. 8. As discussed above, the operation of reducing the quantities of materials to such particles can be accomplished in any suitable manner. Examples of suitable regrinding methods include, but are not limited to, grinding, shredding, pulverizing, and the like. Thus, method 600 can also optionally include making a determination as to an appropriate size for reducing the quantities of materials to particles, as is represented by box 622 in FIG. 8. It will further be recognized that such a determination will vary from application-to-application depending upon a wide variety of factors, such as material properties and downstream manufacturing operations.

Regardless of the manner in form, manner and/or conditions under which the quantities of polymeric material are provided, once the primary polymer and one or more non-primary polymers have been reduced to particles of the predetermined size, method 600 can also optionally include making a determination as to the ratio or relative percentage of primary polymer-to-non-primary polymer that is desired, as is indicated by box 624 in FIG. 8. It will be appreciated that such a determination can be made using any suitable factors and/or criteria, and that the same will vary from application-to-application. For example, in some cases, the primary polymer may comprise at least 75 percent of the material of the section of polymeric sheet material with the one or more non-primary polymers comprising as much as 25 percent thereof. In other cases, the primary polymer may comprise at least 90 percent of the material of the section of polymeric sheet material with the one or more non-primary polymers comprising 10 percent or less thereof. In still other cases, the primary polymer may comprise more than 95 percent of the material of the section of polymeric sheet material with the one or more non-primary polymers comprising less than 5 percent thereof. In still further cases, the primary polymer may comprise more than 98 percent of the material of the section of polymeric sheet material with the one or more non-primary polymers comprising less than 2 percent thereof. Percentages can be determined by volume or mass.

Plastic cards constructed from a material comprising recycled scrap material, methods of forming such cards, and methods for a process that continuously recycles scrap material have been described with reference to the various exemplary embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A section of polymeric sheet material having opposing sheet sides and an outer peripheral edge, said section of polymeric sheet material comprising:
a quantity of primary polymer having a processing temperature and comprising at least 50 percent of said section of polymeric sheet material; and,
a plurality of particles of at least one non-primary polymer having a processing temperature greater than said processing temperature of said primary polymer such that said plurality of particles of said at least one non-primary polymer remain unmelted during manufacture of said section and become at least partially embedded within said quantity of primary polymer.

2. A plastic card formed from a section of polymeric sheet material according to claim 1, said plastic card including opposing sides and an outer peripheral edge, and said plastic card including a magnetic strip disposed along one of said opposing sides.

3. A section of polymeric sheet material according to claim 1 or 2, wherein said at least one non-primary polymer includes at least one of polyolefin, polyamide, polystyrene, nylon, polyester, polyestercopolymer, polyurethane, polyacrylate, polysulfone, styrene-maleic anhydride copolymer, styrene-acrylonitrile copolymer, ionomer based on sodium or zinc salts of ethylene methacrylic acid, polymethyl methacrylate, fluoroplastic, polycarbonate, polyacrylonitrile, polycyanurate, ethylene-vinyl acetate copolymer.

4. A section of polymeric sheet material according to claim 1 or 2, wherein at least a portion of said quantity of primary polymer is originally intermixed with said at least one non-primary polymer.

5. A section of polymeric sheet material according to claim 1 or 2 further comprising a layer of primary polymer disposed along one of said opposing sheet sides such that a portion of said plurality of particles of said at least one non-primary polymer is covered by said layer of primary polymer.

6. A section of polymeric sheet material according to claim 5, wherein in said layer of primary polymer is a first layer and said section of polymeric sheet material further comprises a second layer disposed along the other of said opposing sheet sides such that at least 90 percent of said plurality of particles of said at least one non-primary polymer are covered by said first and second layers of primary polymer.

7. A section of polymeric sheet material according to claim 5, wherein said layer of primary polymer is opaque and at least partially visually obscures a portion of said plurality of particles of said at least one non-primary polymer.

8. A section of polymeric sheet material according to claim 1 or 2, wherein said quantity of primary polymer comprises at least 75 percent of said section of polymeric sheet material and said plurality of particles of said at least one non-primary polymer comprise as much as 25 percent of said section of polymeric sheet material.

9. A section of polymeric sheet material according to claim 8, wherein said quantity of primary polymer comprises at least 90 percent of said section of polymeric sheet material and said plurality of particles of said at least one non-primary polymer comprise as much as 10 percent of said section of polymeric sheet material.

10. A section of polymeric sheet material according to claim 9, wherein said quantity of primary polymer comprises at least 95 percent of said section of polymeric sheet material and said plurality of particles of said at least one non-primary polymer comprise as much as 5 percent of said section of polymeric sheet material.

11. A section of polymeric sheet material according to claim 1 or 2, wherein said plurality of particles of said at least one non-primary polymer are of an approximately uniform size within a range of from approximately 0.01 inches to approximately 0.25 inches.

12. A section of polymeric sheet material according to claim 11, wherein said approximately uniform size includes particles of from approximately 0.02 inches to approximately 0.5 inches.

13. A section of polymeric sheet material according to claim 1 or 2, wherein said quantity of primary polymer consists essentially of polyvinyl chloride.

14. A section of polymeric sheet material according to claim 13, wherein said polyvinyl chloride includes at least one of virgin polyvinyl chloride resin and recycled polyvinyl chloride scrap material.

15. A method of manufacturing polymeric sheet material, said method comprising:
a) providing a first quantity of polymeric material comprising a primary polymer having a first processing temperature and at least one non-primary polymer intermixed therewith and having a second processing temperature greater than said first processing temperature;
b) reducing at least said first quantity of polymeric material to polymeric particles of a predetermined and approximately-uniform size; and,
d) processing said first quantity of polymeric material at approximately said first processing temperature to form a section of polymeric sheet material comprising said primary polymer and a plurality of unmelted particles of said non-primary polymer at least partially embedded within said primary polymer.

16. A method according to claim 15 further comprising forming said section of polymeric sheet material into one or more plastic cards comprising said primary polymer and a plurality of unmelted particles of said non-primary polymer at least partially embedded within said primary polymer.

17. A method according to claim 15, wherein said section of polymeric sheet material has opposing sides, and said method further comprises applying an opaque coating along at least one of said opposing sides such that a portion of said plurality of unmelted particles of said non-primary polymer is at least partially obscured thereby.

18. A method according to claim 15, wherein said section of polymeric sheet material has opposing sides, and said method further comprises applying a layer of said primary polymer along at least one of said opposing sides such that a portion of said plurality of unmelted particles of said non-primary polymer is covered thereby.

19. A method according to claim 18, wherein said layer of primary polymer is opaque such that said portion of said plurality of unmelted particles of said non-primary polymer is visually obscured by said layer.

20. A method according to claim 18 further comprising forming said layer of primary polymer from a quantity of primary polymer comprising recycled scrap material prior to applying said layer along said at least one of said opposing sides of said section of polymeric sheet material.

21. A method according to claim 18 further comprising applying a layer of said primary polymer along each of said opposing sides of said section of polymeric sheet material.

22. A method of manufacturing polymeric sheet material, said method comprising:
a) providing a first quantity of polymeric material comprising a primary polymer having a first processing temperature;
b) providing a second quantity of polymeric material comprising a combination of said primary polymer and at least one non-primary polymer intermixed therewith, said at least one non-primary polymer having a second processing temperature greater than said first processing temperature;
c) reducing at least said second quantity of polymeric material to polymeric particles of a predetermined and approximately-uniform size; and,
d) processing a predetermined percentage of said first and second polymeric materials together with one another at approximately said first processing temperature to form a section of polymeric sheet material comprising said primary polymer and a plurality of unmelted particles of said non-primary polymer at least partially embedded within said primary polymer.

23. A method according to claim 22, wherein reducing said second quantity of polymeric material in c) includes selecting a predetermined size from within a range of approximately 0.01 inches to approximately 0.25 inches.

24. A method according to claim 22, wherein said first quantity of polymeric material includes recycled scrap material consisting essentially of said primary polymer.

25. A method according to claim 22, wherein said first quantity of polymeric material includes virgin polymeric material consisting essentially of said primary polymer.

26. A method according to claim 22 further comprising determining a percentage of said second quantity of polymeric material to combine with said first quantity of polymeric material and utilizing said percentage as said predetermined percentage in d).

27. A method according to claim 26, wherein determining said percentage includes selecting a percentage from within a range of approximately 0.5 percent to approximately 40 percent.
